(19) United States
(12) Patent Application Publication
(10) Pub. No.: US 2008/0080515 A1
(43) Pub. Date: Apr. 3, 2008

(54) MARKER FOR COMMUNICATION SYSTEMS CONSISTING OF MULTIPLE SIP SERVERS

(75) Inventors: Dimitri TOMBROFF, Massy (FR); Christophe Lebel, Haute Goulaine (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/863,794

(22) Filed: Sep. 28, 2007

(30) Foreign Application Priority Data
Oct. 2, 2006 (FR) 0654035

(51) Int. Cl. H04L 12/28

(52) U.S. Cl. 370/394

(57) ABSTRACT

Communication system (S) able to exchange SIP signaling messages, with a communication network (N), containing multiple servers (S₁, S₂, S₃ . . . Sₙ) to handle incoming messages (mₛ) and generate outgoing messages and a load distribution device (LB) to route an incoming message to a particular server according to load distribution rules (R, R_{aff}). The servers have means to include in the outgoing messages a marker representing at least itself, and the load distribution rules of the load distribution device contain rules (R) so that, when a marker is included in an incoming message, it can be routed to the server corresponding to the marker.

This invention relates to communication networks. More precisely, it concerns a communication system able to exchange signaling messages, in particular compliant with the SIP protocol, with a communication network.

The SIP protocol is commonly used to allow two parties (usually two terminals) to set up a connection through a communication network. This protocol is defined by RFC 3261 of the IETF (Internet Engineering Task Force) entitled “SIP: Session Initiation Protocol”, but is also the subject of extensions, also defined by RFCs of the IETF.

SIP protocol defines two types of communication system: terminals (or “agents” to use the SIP protocol terminology) and “Proxy” signaling elements. The role of the “proxies” is to facilitate the connection between the terminals. Indeed, a terminal is known within a communication network by a physical address, while terminal users are identified by logical addresses. When users wish to reach a correspondent, they generally only have their logical address. The aim of the signaling elements is, among other things, to carry out this connection between the logical address of the correspondent and the physical address of its terminal.

The terminal which requires communication to be set up is called a “client” or UAC (“User Agent Client”). The called terminal is called the “server” (UAS for “User Agent Server”).

With the emergence of so-called IMS (“IP Multimedia Subsystem”) architectures, standardized both by 3GPP and by TiSpan, the SIP protocol takes on even greater importance and the signaling elements have ever more signaling messages to handle.

It therefore becomes necessary to propose solutions allowing the different types of signaling elements to handle this increasing volume of messages. It has therefore been planned to have more devices to implement a signaling element.

Such architectures are used in other contexts, as shown for example in the article “Introduction to Server Clustering”, published on the website of the company Cisco, which presents the advantages of these groups (or “clusters”) of devices.

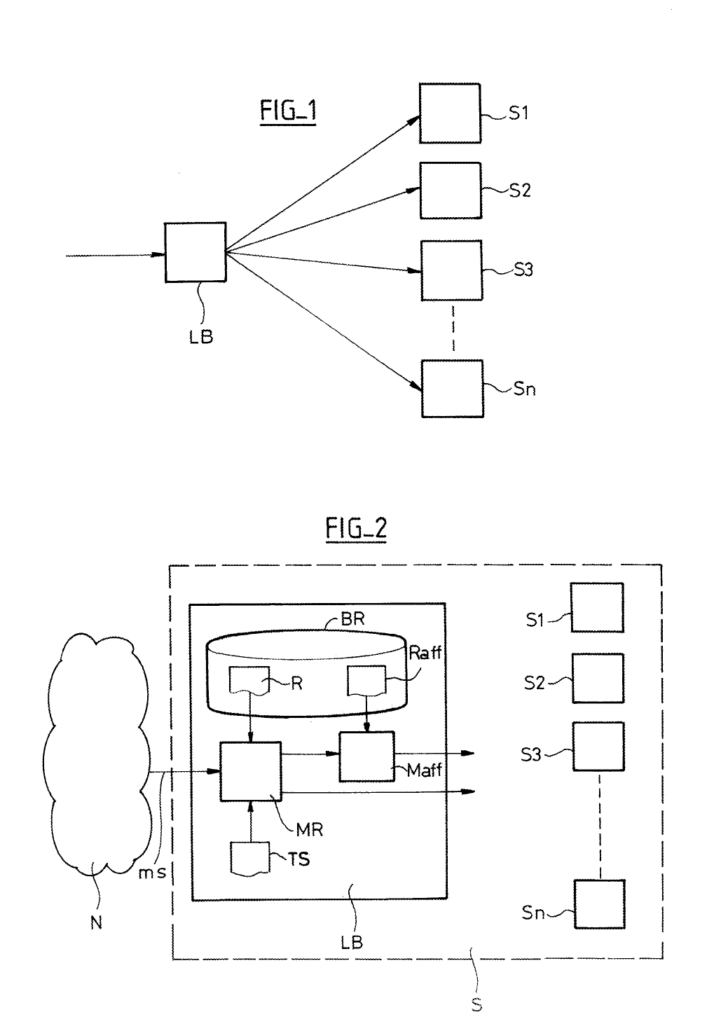

FIG. 1 provides a simplified illustration of this type of architecture.

It is based on a specific device LB which distributes the load across multiple handling devices, or servers, S1, S2, S3 . . . Sn. When a service request SR reaches the group of devices, the load distribution device LB routes it to a particular server, here S3, according to load distribution rules.

However, the application of this architecture for SIP signaling elements (or terminals) poses problems due to the specific features of the operation of a communication session and the SIP protocol.

In particular, the current solutions based on groups of devices so not take sufficient account of the fact that the management of a call requires a context to be set up. In effect, when a second signaling message reaches the signaling device, it needs to retrieve this context in order to be able to handle it.

However, in these solutions there is no mechanism making this context available: if the first message has been handled by a device (for example S3), the context relating to this handling and to the call or session corresponding to this message is contained in this server S3.

When a second signaling message reaches the load distribution device LB, two sets of solutions are possible.

According to a first set of solutions, the load distribution device acts as in the general solutions described above (for example the Cisco article). A subsequent signaling message therefore reaches a different server to the one which handled the previous message. A mechanism is then implemented to send the context memorized in the first server to the second server.

This approach poses the problem of having to repeatedly transfer the context from one server to another. This mechanism is also very costly and does not allow efficient deployment when the site receives a large number of signaling messages at a high rate.

According to a second set of solutions, the load distribution device memorizes associations between a communication session identifier and the server in charge of this session. This association is created during the reception of the first signaling message corresponding to this session, and used to route the following messages to the same server. This identifier is usually made up of the “Call-Id”, “From” and “To” headers of the SIP signaling messages.

The associations are usually stored in a memory database of the load distribution device LB, in order to guarantee sufficiently quick access.

These solutions do however have at least four further disadvantages.

Firstly, the load distribution device LB cannot know the duration of the communication session. It is therefore difficult to implement an expiry strategy for the memorized associations. If the expiry time is too short, the association will be deleted from the database when signaling messages relating to this session continue to arrive. If the time is too long, it may result in the database becoming overloaded.

Secondly, it is difficult to deploy this solution so that it tolerates faults in the load distribution device, without having too heavy an impact on its performances.

In effect, if the load distribution device suffers a failure, the information relating to the associations contained in its database are lost. Even when the load distribution device returns to operation, it cannot route the signaling messages to the correct servers. This may then result in interruptions to the communication sessions.

To get around this problem, it is possible to memorize the associations on a remote base, or to put in place mechanisms so that the servers redirect the incorrectly routed signaling messages to the correct server. However, this mechanism is costly to implement in terms of performances.

Thirdly, certain SIP applications combine several communication sessions, each identified by a different “Call Id”.

This is, for example, the case of a signaling element known as “B2BUA” (“back-to-back User Agent”). Such an element plays the role of a SIP server with regard to the calling party and of a client with regard to the called party. End-to-end communication is made up of two separate sessions: a first session between the calling party and the signaling element (then considered to be a SIP server) and a second session between the signaling element (then considered to be a SIP client) and the called party.

The different sessions need to be handled by the same server. The load distribution device must therefore maintain a dual association between the two sessions and the server handling them. However, in particular in the case of a server failure, it is very complicated to ensure that the load distribution device has the information required to route the signaling messages to the appropriate server. Therefore, it may occur that both sessions are recreated on two different servers, and a server needs to redirect the signaling messages received to the correct server.

Fourthly, there are different applications based on the SIP protocol in which the same “application” session may require several “protocol” sessions: A load distribution based on a session identifier like the “Call-id” header cannot therefore guarantee that all the messages of the same “application” session are handled by the same server. This type of application is known as “multi-call”.

This is, for example, the case for elements known as S-CSCF (“Serving-Call Session Control Function”) within an IMS architecture.

An S-CSCF receives terminal registration signaling messages (“Register” messages), then invitation to call signaling messages (“Invite” messages) or others (“Publish” messages, etc.). The first registration message allows the terminal to be authenticated by the IMS communication network, and therefore to be permitted to send calls through this network. These different messages do not have the same “Call id” session identifiers, and in fact form different “protocol sessions”.

Therefore, the load distribution device of the S-CSCF cannot route the signaling messages belonging to the same terminal (and which form part of the same “application session”) to the same server. In order to determine whether a following signaling message (“Invite”, “Publish”, etc.) corresponds to a terminal which has previously been authenticated by a server of the S-CSCF, the latter must be planned so that the contexts can be sent from one server to another. This obligation obviously adds an extra cost in terms of the handling time for signaling messages and similarly reduces the general performances of the IMS system.

A second example concerns the presence and the management of the “Publish” signaling messages which allows a client to update its presence information. This type of signaling message is described in RFC 3903 of the IETF, entitled “Session Initiation Protocol (SIP) Extension for Event State Publication” and published in October 2004.

The same client may be required to send several “Publish” messages, depending on the activity of the user. Each of its “Publish” messages contains a different “Call-id” session identifier, and therefore forms as many “protocol sessions” (from the point of view of the SIP protocol, these are different sessions). However, all of these sessions belong to the same application session. Ideally, they should therefore be handled by the same server so that this server has the whole context related to this application session.

Different solutions have been proposed, based on the use of a marker.

For example, the American patent applications US2004/103194, US2004/153497 and the European application EP1599015 propose that a server identifier assigned to a session be sent to the client. The client then sends subsequent messages directly to the server, without passing via the load distribution device. This then no longer fulfills the role of routing signaling messages.

These solutions suffer from the fact that they do not tolerate faults: no recovery mechanism is proposed in the event of a malfunction in the assigned server.

The American patent application US2004/152469 also proposes the insertion of a marker inside the signaling messages used to determine whether an incoming message is a first message and if not, to determine a session identifier and route the message to the server associated with this session identifier.

This solution however has the same first and second disadvantages given above: the load distribution device needs to maintain session contexts and, in particular, a base associating the open sessions and the assigned servers. The load distribution device is said to be “stateful”.

It is therefore necessary to propose an architecture of a communication system which does not have these disadvantages. The aim of the invention is to provide such an architecture.

More precisely, the first aim of the invention is to provide a communication system able to exchange signaling messages, in particular compliant with the SIP protocol, with a communication network. The communication system contains multiple servers to handle the incoming signaling messages and generate outgoing signaling messages and a load distribution device to route an incoming signaling message to a particular server according to load distribution rules.

The communication system according to the invention is characterized in that
the servers have the means to include in outgoing signaling messages a marker representing at least itself, and in that
the load distribution rules of the load distribution device contain rules so that, when a marker is included in an incoming signaling message, the incoming signaling message can be routed to the server corresponding to this marker.

The communication system according to the invention may have several functions: UAC client terminal (or agent), UAS server terminal, signaling element (“proxy”) . . . or of course a combination of these functions. It may also be a “B2BUA” (“back-to-back User Agent”) type signaling element.

Therefore, through the use of a marker identifying a server within the communication system, the applications can ensure that all of the signaling messages will be routed to this server.

It is no longer necessary for the load distribution device to maintain a database of the associations between “Call Id” and server, since the routing is based on a marker. It simply needs an association table, of reduced size, showing the correspondence between the values of the marker and the addresses of the servers.

It should however be noted that it may be useful to retain a table of the correspondence between session identifiers (“call Id”) and servers to manage resending. Indeed, according to the SIP protocol a client should resend its request all the time it has not received a response from the server. In the case of the initial messages, for which a context and therefore a marker have not yet been determined, it is important that the repeated messages be directed to the same server. A table of the correspondence between “call Id” and server similar to those of the state of the art may therefore be implemented, but the time granted for resending is limited by the SIP protocol, meaning that the associations can expire after a known and relatively short time.

The association table therefore remains at a reasonable size which does not lead to any of the previously mentioned problems.

In particular, the previously mentioned problem of the determination of a correct expiry value for the associations therefore no longer arises. Likewise, a failure of the load distribution device no longer poses a real problem since the device no longer contains dynamic information on the state of the system (it is said to be “State-less”).

When the same communication leads to several session identifiers, as in the case of the “back-to-back” signaling element mentioned above, the application can naturally ensure that these sessions are all handled by the same server, using the same marker value.

The same applies for the case of the S-CSCF: the use of the same marker for the “Register” and “Invite” messages ensures the handling by the same server, without it being necessary to proceed with transfers of context from one server to the other.

The communication system according to the invention therefore provides an elegant solution to all of the problems raised by the state of the art solutions.

According to one embodiment of the invention, the markers contain at least a first part representing the communication system and identifying it unambiguously within the communication network.

The markers may also contain a second part representing the servers and identifying them unambiguously within the communication system.

This second part may be made up of an abstract identifier based on the physical address of one of the servers. In this scenario, the load distribution device has a server table showing the correspondence between this abstract identifier and the physical address.

The markers also contain a third part representing the context associated with the signaling messages.

Furthermore, the servers can include the markers in a standardized and unique position in the signaling messages. Alternatively, they can include these markers in a position dependent upon the function of the communication system.

The load distribution rules of the load distribution device may contain rules so that, when no marker is included in an incoming signaling message, a server can be assigned to this incoming signaling message.

The second aim of the invention is to provide an intermediate signaling element (or “proxy”) containing a communication system according to the first aim of the invention. The markers can, in this situation, be included in the “Via” and/or “Record route” headers.

The third aim of the invention is to provide a B2BUA type signaling element containing a communication system according to the first aim of the invention, in which the markers are included both in the “From” header and in the “To” header with an identical value.

A fourth aim of the invention is to provide a communication terminal containing a communication system according to the first aim of the invention. The markers can in this case be included in the “From” field when the terminal has the role of client, and in the “To” field when it has the role of server.

The fifth aim of the invention is a communication network containing at least one signaling element compliant with the second aim of the invention and the means allowing signaling messages to be sent between communication terminals and the signaling element(s). The communication terminals may optionally be compliant with the fourth aim of the invention.

A sixth aim of the invention concerns a method for sending signaling messages between a calling communication terminal and a server communication terminal, implementing a signaling element according to the second aim of the invention.

The invention, in its different aims, will be clearer in the description which follows, together with the attached figures.

FIG. 1, previously mentioned, shows a simplified representation of a device group (or “cluster”) architecture.

FIG. 2 shows in diagram form a possible functional architecture of a communication system according to an embodiment of the invention.

The communication system according to the invention can be a signaling element, in particular a CSCF (“Call Session Control Function”) of an IMS architecture, but also a client (UAC for “User Agent Client” or server (UAS for “User Agent Server”) communication terminal.

Such a communication system is shown in diagram form in FIG. 2. The communication system S is intended to exchange signaling messages ms with the communication network N. The signaling messages usually comply with the SIP protocol defined by the IETF.

The signaling messages ms reach a load distribution device LB, the function of which is to route these signaling messages to the “correct” server S1, S2, S3 . . . Sn.

FIG. 2 shows in diagram form a possible functional architecture for the load distribution device LB, but it is important to note that this is a functional architecture susceptible to various physical implementations. It is provided mainly by way of explanation in order to show the invention more clearly.

According to this embodiment, the load distribution device LB has a routing module MR which, in cooperation with a rules base BR, is used to route the incoming signaling messages ms to a particular server among the multiple servers S1, S2, S3 . . . Sn which the communication system S possesses.

On receiving a signaling message ms, the routing module MR checks for the presence of a marker in the message.

Certain rules R contained in the base BR specify that in the presence of a marker, the signaling message ms must be routed to the server corresponding to this marker.

The marker identifies a particular server of the communication system S. This may be the physical address of this server or an identifier that the routing module MR can connect with the physical address using a server table TS.

Once this physical address is determined, the routing module MR can route to the corresponding server.

According to the invention, all the signaling messages corresponding to the same communication contain the same marker and as a result lead to the determination of the same physical address. They are therefore all routed to the same server and associated with the same context.

This context represents all the information used to handle a signaling message. It therefore depends on the signaling messages already received. It can also contain information retrieved from an external base (presence server, application server, etc.)

In other words, the presence of a marker indicates that a context already exists in the communication system for the communication to which the incoming signaling message ms corresponds. By using the marker to route it, it is guaranteed that the server which has this context which will handle it.

In the event that a signaling message ms does not contain a marker, this means that no context exists for the communication corresponding to this incoming message. This is a first signaling message for a given communication.

The load distribution device LB has an assignment module Maff to assign the context to a server. To do this, it has assignment rules Raff which may be similar to those existing in the solutions of the state of the art.

These assignment rules may simply involve assigning each new context in turn to the next server up: in this way, for example, the first context is assigned to the server S1, the second to the server S2 and so on.

Other more complex mechanisms may be implemented, based in particular on the actual load of the servers in order to assign a new context to the least loaded server.

When the assignment is determined by the assignment module Maff, the signaling message ms is routed to the corresponding server.

It should be noted that the load distribution device LB does not memorize this assignment, nor does it introduce additional information into the signaling message ms sent to the server.

The servers have means to include in the outgoing signaling messages a marker representing itself, in other words allowing the load distribution device to identify it from among the multiple servers S1, S2, S3 . . . Sn contained in the communication system S.

In this way the other party receiving the outgoing signaling message will know the marker. By using this marker in the other signaling messages destined to the communication system S, it will be assured that they will be handled by the same server.

More precisely, this marker may consist of several parts.

A first part may be representative of the communication system S itself. It allows the load distribution device LB receiving a signaling message to ensure that it is the correct recipient for this message and that the marker is effectively a marker which concerns this device.

It must therefore be a value providing an unambiguous identification of the communication system S within a communication network. In the event that this communication system S forms part of the worldwide network, commonly known as the Internet, the value must therefore be unique on a worldwide level.

This first part may for example be the MAC address of the load distribution device or based on it. The MAC (“Media Access Control”) address effectively provides a unique definition of a network device. Several types of MAC address exist, in particular MAC-48, EUI-48 and EUI-64 defined by the IEEE (Institution of Electrical and Electronics Engineers).

This first part can also be the IP address of the communication system S, or based on it.

The marker can also contain a second part representing the server. Its role is to identify the server unambiguously within the communication system S, so that the load distribution device LB can route the incoming signaling message to a clearly determined server.

This second part may consist of the physical address of the server (MAC address . . . ) or a more abstract identifier based on this. In the latter case, it is assumed that the load distribution device LB has a server table TS showing the correspondence between this abstract identifier and the physical address of the server. This second part therefore allows the load distribution device LB to route the incoming messages to the “correct” server.

This second part can also identify a software process. The correspondence between the identified software process and the server can be made transparently by the software infrastructure (“middleware”) implemented in the communication system S. Software infrastructures in effect are used to mask the position of the software processes within a distributed system, by taking responsibility for routing the messages addressed to a given process towards the device on which it is located, in a manner which is transparent for the applications.

Lastly, the marker may have a third part containing an identifier for the SIP application instance, and representing the session context. This third part representing the session context is useful for locating the context when the software process or the server determined by the second part of the marker is not operational.

This third part is not necessary when the server is made tolerant to faults by an N-N redundancy. In such a situation, the load distribution device LB may in effect maintain a table associating a redundant server with each active server. When an active server ceases to be operational, it may then route the messages which are addressed to it towards the redundant server which also has the context of the application associated with the incoming message.

In the case of N+1 redundancy, the contexts contained by a server are duplicated in all (or a sub-set) of the other servers. The knowledge of the server to which a message must be routed is not therefore enough for the load distribution device to determine how to route this message during the failure of this server: it needs to know the context.

By determining the context from this third part and using a reference table allowing the association of a context with a server (or a software process), the load distribution device LB is able to route the incoming signaling message to the correct server in the communication system S.

The marker can be included in different positions in the signaling messages.

According to a first embodiment, the marker is included in a standardized and unique position in the signaling messages (incoming and outgoing). This may be a header of the specific SIP protocol, standardized with the IETF. However, such an implementation requires the modification of the existing communication terminals so that they comply with this new standardization and are able to interpret the signaling messages received and generate messages themselves.

The invention therefore also proposes a second execution method, compliant with the current SIP protocol standardization and which does not require the modification of the terminals deployed.

To do this, the communication system S is able to include the markers in positions dependent upon its function. In other words, the position in which the markers are included is different for a communication system with a “proxy” function, or a client or server terminal function. Remember that the same communication system can have several functions, and therefore can adapt to the function that it takes for a given session.

Therefore, in the case of a UAC client, the marker is included in the “From” header of the outgoing signaling messages. More precisely, it can be included as a parameter within this header.

In the case of a UAS server client, the marker is included in the “To” header of the outgoing signaling messages. It can also more precisely be included as a parameter within this header.

In either case, this parameter can be the “tag” parameter.

It may however not be included in the case of outgoing signaling messages which do not require a response from the other party (i.e. the UAC client), in other words messages “100 Trying” and error messages.

As a result, a communication terminal with a communication system according to the invention can include the marker in the “From” field when it has the role of client, and in the “To” field when it has the role of server.

In the case of an intermediate SIP signaling element, or “proxy”, the “From” and “To” headers cannot generally be modified.

The marker is then included in the “branch” parameter of the last (in chronological order) “Via” header of each outgoing signaling message.

A “Via” header is used by the SIP terminal elements to re-route the responses by the same nodes as the requests of the outbound path.

In certain cases, furthermore, certain intermediate signaling elements, or “proxies”, modify the “Record Route” headers and the routing of a response message in the communication network is based on these “Record Route” headers. In this case, the marker is also included in a parameter of the “Record route” header of each outgoing signaling message.

The “Record-Route” header is used by the SIP terminal elements to route the subsequent messages by the nodes which made the request on the outbound path.

In the case of a “B2BUA” (“back-to-back User Agent”) type signaling element, the behavior of both a UAS server (for example with regard to the caller) and of a UAC client (with regard to the next element in the chain; for example the called party) can be adopted. Therefore, as a server, the B2BUA signaling element can insert the marker in the “To” header, and as a client it can insert it in the “From” header.

Since the marker is the same in both cases, the problem mentioned previously of two sessions being open within the same “B2BUA” signaling element is therefore resolved.

The marker can also be included in the “Service Route” header by an intermediate signaling element with the role of an S-CSCF element in an IMS architecture. This “Service Route” header is defined in RFC 3608 of the IETF, entitled “Session Initiation Protocol (SIP) Extension Header Field for Service Route Discovery During Registration” and published in October 2003.

This “Service Route” header is included in the response messages to the “Register” requests made by the clients wishing to connect to the IMS network. Therefore, the following messages (“Invite”, “Publish”, etc.) can contain this marker so that the S-CSCF element can identify that they belong to the same application session and route them to the same server. This problem relating to the S-CSCF elements, presented previously in the introduction part is therefore resolved by the insertion of the marker.

In the same way, the presence servers can include the marker in the “Entity Tags” header of the response messages to the “Publish” requests from the clients (terminals). In the same way as previously, this allows the clients to use the marker in their following messages (other “Publish” messages during a new update of the user profile, for example). Therefore, the presence server can determine that these signaling messages all belong to the same “application” context and route them to the same server within the communication system S. The problem posed by the presence servers and mentioned in the introduction part is therefore also resolved by the use of the marker.

In all of these cases, the marker can be inserted in the header by the use of a separator (“;” according to the grammar of the SIP protocol) and introduced by a specific keyword (for example the chain “marker=”). It can also be inserted without the use of a keyword.

1. Communication system (S) able to exchange signaling messages, in particular compliant with the SIP protocol, with a communication network (N), containing multiple servers (S₁, S₂, S₃ . . . Sₙ) to handle the incoming signaling messages (mₛ) and generate outgoing signaling messages and a load distribution device (LB) to route an incoming signaling message to a particular server according to load distribution rules (R, R^{aff}), characterized in that
said servers have the means to include in the outgoing signaling messages a marker representing at least itself, and in that said load distribution rules of said load distribution device contain rules (R) so that, when a marker is included in an incoming signaling message, said incoming signaling message can be routed to the server corresponding to said marker.

2. Communication system according to claim 1, in which the markers contain at least a first part representing said communication system and identifying it unambiguously within said communication network.

3. Communication system according to claim 2, in which the markers also contain a second part representing said servers and identifying them unambiguously within said communication system.

4. Communication system according to claim 3, in which said second part consists of an abstract identifier based on the physical address of one of said servers, said load distribution device having a server table (TS) showing the correspondence between said abstract identifier and said physical address.

5. Communication system according to claim 3, in which said markers also contain a third part representing the context associated with the signaling messages.

6. Communication system according to claim 1, in which said servers include the markers in a standardized and unique position in the signaling messages.

7. Communication system according to claim 1, in which said servers include said markers in a position dependent upon the function of said communication system.

8. Communication system (S) according to claim 1, in which said load distribution rules of said load distribution device contain rules (Rff) so that, when no marker is included in an incoming signaling message, a server can be assigned to said incoming signaling message.

9. Intermediate signaling element containing a communication system according to claim 1.

10. Intermediate signaling element according to claim 9, in which said markers are included in the “Via” and/or “Record route” headers.

11. B2BUA type signaling element containing a communication system according to claim 1, in which said markers are included both in the “From” header and in the “To” header with an identical value.

12. Communication terminal containing a communication system according to claim 1.

13. Communication terminal according to claim 12 in which said markers are included in the “From” field when said terminal has the role of client, and in the “To” field when it has the role of server.

14. Communication network containing at least one signaling element according to claim 9 and means allowing the sending of signaling messages between communication terminals and said at least one signaling element.

15. Communication network containing at least one signaling element and plural communication terminals and means allowing the sending of signaling messages between communication terminals and said at least one signaling element, wherein said signaling element and at least some of said communication terminals include a communication system according to claim 1.

16. Method for the sending of signaling messages between a calling communication terminal and a server communication terminal, implementing a signaling element according to claim 9.
